(19) United States
(12) Patent Application Publication
(10) Pub. No.: US 2008/0109464 A1
(43) Pub. Date: May 8, 2008

(54) Extending Clipboard Augmentation

(75) Inventors: Raymond E. Ozzie, Seattle, WA (US); Jack E. Ozzie, North Bend, WA (US); Paresh S. Suthar, Redmond, WA (US); Raman Narayanan, Kirkland, WA (US); Matthew S. Augustine, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/621,433

(22) Filed: Jan. 9, 2007

Related U.S. Application Data
(63) Continuation-in-part of application No. 11/557,004, filed on Nov. 6, 2006.

(51) Int. Cl. G06F 17/30

(52) U.S. Cl. 707/101; 707/E17.005

(57) ABSTRACT

Systems, methods, and data structures for the augmenting of data placed on the clipboard with additional data are disclosed. Such systems, methods, and data structures may transform the data to produce data in other formats using, for example, transform specifications or executable code. In addition, such systems, methods, and data structures may be extended to add support for new or changed data formats.

### CROSS-REFERENCE TO RELATED APPLICATIONS

This application is a continuation-in-part of U.S. patent application Ser. No. 11/557,004, filed Nov. 6, 2006, which is incorporated by reference herein in its entirety.

### BACKGROUND

Users of modern operating systems and applications may be accustomed to using a “clipboard” to copy and paste a wide variety of data between different screens and applications. In addition to holding multiple clipboard data items, some clipboard systems have the ability to represent or contain multiple formats for a given item. For example, when a user copies, say, a set of cells from a spreadsheet, the spreadsheet application may place those cells on the clipboard in multiple formats. For example, for the copied spreadsheet cells, a clipboard might contain a plain text representation, a formatted text representation (in one or more of a variety of formats), an image representation, an application-specific representation that contains all of the cell information, and so on. When a user pastes the spreadsheet cells into a particular application, the application may request or use a particular format. For example, a text editor may only understand and use the plain text representation, an image editing program may use the image representation, another instance of the same spreadsheet application may use the spreadsheet data, and so on.

While a clipboard system may have the capability of supporting multiple formats for the same item, it is not always the case that a particular format used or required by a destination is included in the format or formats provided by the source of the data. As just one example, a personal information management (PIM) application may have the ability to automatically create a contact, with the appropriate fields already populated, when the user pastes data that the PIM application recognizes as a contact. For example, the PIM application might recognize data formatted using the vCard standard. However, even when a source application has all of the information required to create a contact—the name, address, phone number(s), and so on—it may not know how to format this information in a specific format that may be required by some other application. Continuing this example, if the source provides the contact data in another format—like hCard—then the destination may not recognize the data as a contact and may not automatically create a contact using the pasted data.

As a result, the transfer of data between different applications may be limited to a lower fidelity representation, like strings of text. In this example, even if both a source and destination application understand contact data, if they do not exchange contact data in formats supported by both the source and destination applications then a user may still need to, for example, manually copy individual fields—like name, address, and so on—between applications.

In addition, the formats used by a source application or accepted by a destination application may evolve and change as, for example, new versions of applications are written and deployed, new data format standards are proposed and become accepted, and so on. Because of changes like these, source and destination applications may not be able to exchange data using new or changed data formats.

### SUMMARY

The following presents a simplified summary of the disclosure in order to provide a basic understanding to the reader. This summary is not an extensive overview of the disclosure and does not identify key or critical elements of the invention or delineate the scope of the invention. Its sole purpose is to present some concepts disclosed herein in a simplified form as a prelude to the more detailed description that is presented later.

Described herein are various techniques and technologies directed toward augmenting data placed on a clipboard with additional data, based on the data originally placed on the clipboard. In some cases this augmentation may be performed by transforming the data to produce data in other formats. This may in some implementations be accomplished by using some kind of transform system or executable code. In other cases the augmentation might involve resolving a reference, like a URL or the content of an RSS feed, into data indicated by the reference, and placing such data, or other data based on such data, on the clipboard. The augmentations performed may be extended and changed so that, for example, new or changed data formats may be supported.

### DESCRIPTION OF THE DRAWINGS

FIG. 1 illustrates an exemplary generalized operational flow including various operations that may be performed when augmenting data on a clipboard and extending the augmenting of data on the clipboard.

FIG. 2 illustrates an exemplary generalized operational flow including various operations that may be performed when augmenting data on a clipboard and extending the augmenting of data on the clipboard, where the identification of the augmented data may only be performed in some cases when the data is needed during a paste operation.

FIG. 3 illustrates an exemplary system in which clipboard augmentation and augmentation extension may be performed.

FIG. 4 illustrates an exemplary system that includes a graphical example of one mechanism for representing clipboard data, including a transfer representation of data.

FIG. 5 illustrates an exemplary computer device in which the various technologies described herein may be implemented.

### DETAILED DESCRIPTION

The present invention extends to various techniques and technologies directed toward the augmentation of data placed on a clipboard with additional data, based on the data originally placed on the clipboard, as well as the dynamic extension of augmentation capabilities to, for example, support new or changed data formats. More particularly, described herein are, among other things, methods, systems, and data structures that facilitate the augmentation of data on a clipboard and the extension of such augmentation. In some cases augmentation may be performed by transforming the data to produce data in other formats. This may in some implementations be accomplished by using some kind of transform system or executable code. For example, data in one format may be transformed or used to produce data in one or more other formats. In other cases the augmentation might involve resolving a reference, like a URL or the content of an RSS feed, into data indicated by the reference, and placing such data on the clipboard. The augmentations performed may be extended and changed so that, for example, new or changed data formats may be supported.

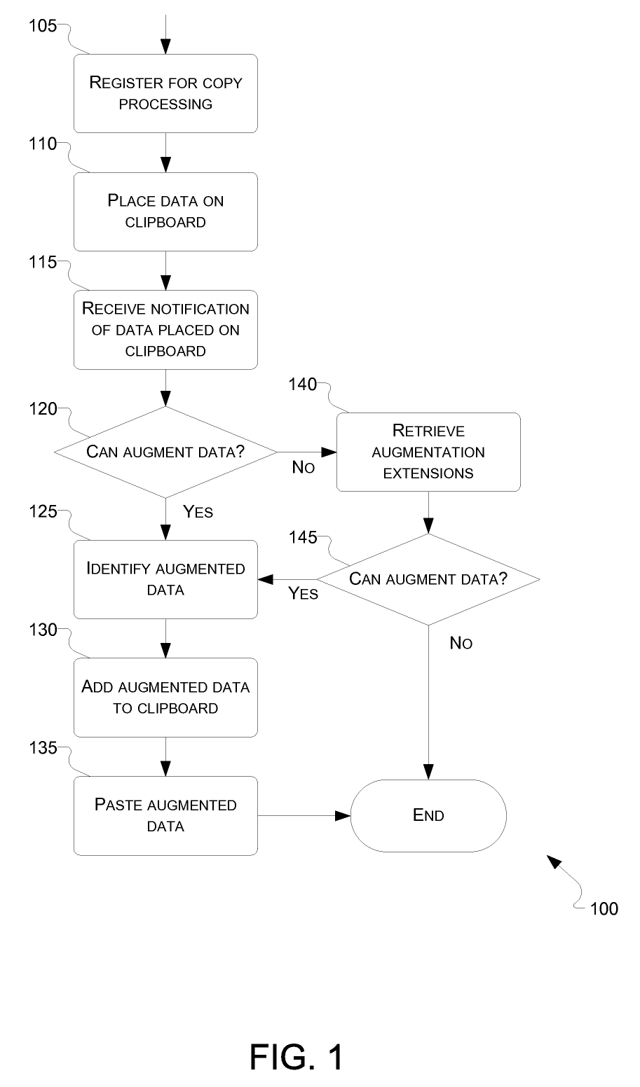

Turning now to FIG. 1, shown therein is an exemplary generalized operational flow 100 including various operations that may be performed when augmenting data on a clipboard and extending the augmenting of data on the clipboard. The following description of FIG. 1 may be made with reference to other figures. However, it should be understood that the operational flow described with reference to FIG. 1 is not intended to be limited to being used with the elements described with reference to these other figures. In addition, while the exemplary operational flow of FIG. 1 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

In at least one implementation of operation 105, the operational flow may register for copy processing. For example, with some clipboard implementations executable code may be registered with the clipboard system so that the clipboard system calls the registered code when certain events happen, including when data is added to or changed on the clipboard. In some implementations, this operation may perform one or more of such registrations so that at some subsequent point in time, when information on the clipboard changes, for example, the registered code may be called. In other implementations, including at least some where the determination of whether data has been added to the clipboard is performed in a different manner, this operation may be performed differently, or may not be needed or performed.

In an exemplary implementation of operation 110, data is placed on a clipboard. This may be accomplished by any of a variety of applications or executable code that has the capability to add data to a clipboard. The data placed on the clipboard may encompass a variety of types of data, including more than one type of data. For example, when a user chooses to copy text in a word processing application, the word processing application may add the text—which is the data being copied in this example—to the clipboard in a variety of formats. One such format added by the word processing application may be a formatted text representation that is perhaps specific to the word processing application. The word processing application might also add formatted text using a common formatted text representation, like Rich Text Format (RTF) or HTML. Such formatted text representations might be useful if the data is later pasted into an application that can recognize or otherwise use formatted text. The same word processing application might also add the copied text in a non-formatted, or plain, text representation. The plain text representation may be useful, for example, when the data is pasted into a text editor that does not understand or display formatted text. The word processing application might also add the text as an image (or may add multiple images). Such image or images may be useful if the text data is pasted into an application—perhaps like an image processing application—that can display images but does not include text editing capabilities.

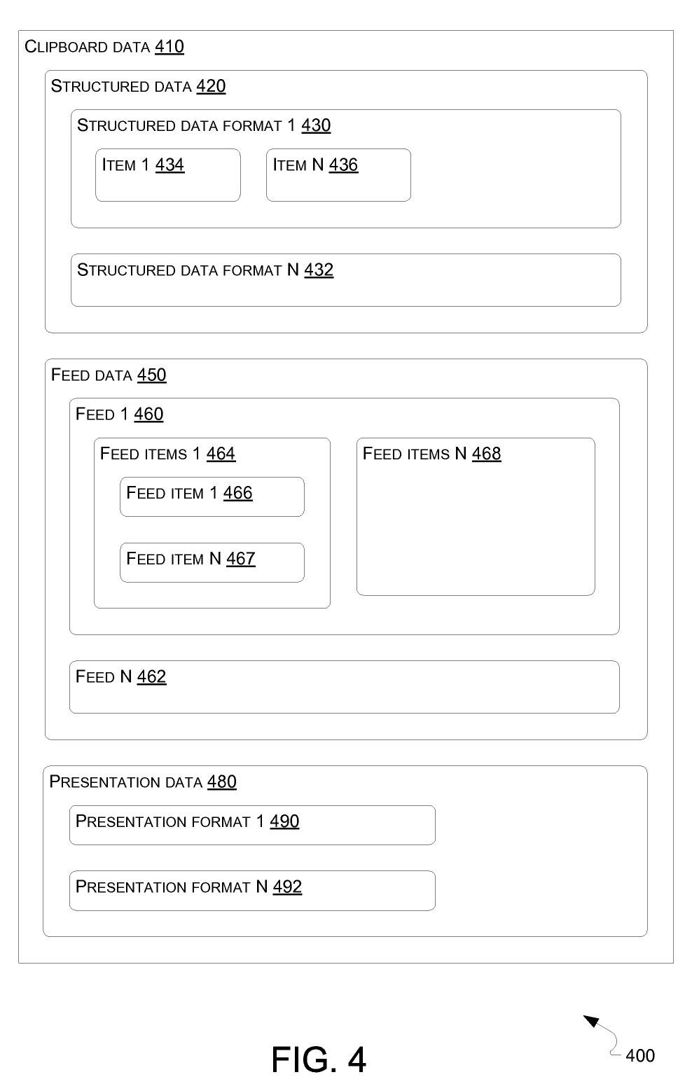

In some implementations, the data that is placed on the clipboard may be represented, at least in part, using some type of container format. For example, rather than just adding a text representation of, say, a contact—including name, address, phone number(s), and so on—in, say, the vCard format, the source application may first “wrap” the vCard data in a container format that may provide additional information about the enclosed data. One such format might be the same as or similar to the container format that is explained in more detail below, with reference to FIG. 4.

In at least one implementation of operation 115, a clipboard augmentation system may receive some type of notification that indicates that data has been placed on the clipboard. This notification may be implemented in a variety of ways. For example, as has been previously described with reference to operation 105, in some clipboard implementations, executable code may be registered with the clipboard system so that the clipboard system calls the registered code when certain events happen, including when data is added to or changed on the clipboard. For example, in such a system, when new data is added to the clipboard, for example, as part of the execution of an operation like operation 110, the clipboard system may implement the notification of operation 115 by calling code that was previously registered with the clipboard system to be called when data is added to the clipboard.

In the same or another implementation, executable code may periodically “poll” the clipboard to determine if the clipboard contains data to be processed or examined. During such a polling operation, if data is found that needs to be processed—for example, perhaps new data has been added to the clipboard since the last polling operation—then the executable code may provide a notification that data has been placed on the clipboard and should be processed. In at least some implementations like this, operation 105 may not be needed or performed.

In an exemplary implementation of operation 120, it is determined if data on the clipboard may be augmented. If the data may not be augmented, the operational flow 100 may proceed to operation 140. If data may be augmented, the operational flow may proceed to operation 125.

The determination of whether data on the clipboard may be augmented may be made using one or more of a variety of criteria. In some implementations, one determining factor may be related to characteristics of the data that was placed on the clipboard and resulted in the notification. For example, the clipboard augmentation code may be able to augment data in one set of formats and not know how to augment data in another set of formats. In an implementation like this, one of the determining factors used to determine if data can be augmented might be whether the data added to the clipboard is in a format that the clipboard augmentation system can recognize and augment. For example, contact information in a particular format may be recognized while general text, contact information in another format, and so on, may not be recognized. Reference information like a URL may be recognized while some other types of reference information may not recognized, and so on.

This determination may also be made in some implementations using a container format, such as, for example, the format described below with reference to FIG. 4. In at least some of these implementations, a system may only be able to augment data that is presented in a particular recognized container format. In some implementations, such systems may also further examine other data provided by the container format to determine if the data may be augmented. For example, if data that uses the format described below with respect to FIG. 4 is added to the clipboard, the type of data—perhaps indicated by the “type” and/or “contenttype” attributes of the data—may be examined. If data of the particular indicated type is recognized and may be augmented, the determination of whether data on the clipboard may be augmented may be made in the affirmative and the operational flow may proceed to operation 125; otherwise the operational flow may proceed to operation 140.

In an exemplary implementation of operation 125, the actual augmented data may be determined. For example, if it is determined that, say, contact data represented using the hCard format may be converted, this operation may convert from the hCard format to some other format like the vCard format or some other contact representation or format. In addition, in some implementations, more than one type of augmented data may be generated. That is, some clipboard augmentation systems may have the ability to generate more than one type of augmented data for particular types of data placed on the clipboard.

The identification of the augmented data may be accomplished in a variety of ways. In some implementations, the augmented data may be identified through the use of some kind of transform system that may in turn use transform specifications. A transform specification may consist of one or more rules or sets of data that define how data in one format may be translated to data in another format. One example of such a transform language may be the Extensible Stylesheet Language Transform (XSLT) language. Given an XSLT transform specification, or with some other type of transform specification, the data added to the clipboard may be transformed to produce some or all of the augmented data. The transformation may be implemented using, for example, an XSLT interpreter that accepts input data and an XSLT transform specification and produces output data.

Another manner in which the augmented data may be determined may be executable code. This executable code may have access to the data that was added to the clipboard and may perform any manipulation, processing, or the like, to produce the desired augmented data. In this context, and in at least some implementations, the executable code may comprise a compiled or otherwise translated representation of executable code. In the same or other implementations, the executable code may also or solely comprise “script” code, including code that may not be compiled and may instead be interpreted or otherwise processed during execution. Such code may include not only script code in a “traditional” programming language, but also any other representation of instructions that may produce augmented data, including representations like human-readable directives stored in a CSV or other file, and so on.

As stated previously, a variety of augmented data may be determined using a variety of mechanisms. As yet another specific example, in cases where the data added to the clipboard includes information in some type of presentation format, perhaps like HTML, at least part of the augmented data may include a representation of the data in that presentation format. The augmented data might in some cases be retrieved directly from the data placed on the clipboard. For example, in cases where the data is represented using a container format similar to or the same as the format described below with reference to FIG. 4, presentation data may be represented using one or more “format” elements that are children of a “presentations” element (presentation data may also exist elsewhere). In at least some implementations, the identified augmented data might include a representation of the data that might be retrieved or associated with information in or beneath the “presentations” element.

Another type of augmented data that might be identified in an at least some implementations of operation 125 might include the result of transferring or duplicating data placed on the clipboard so that the data may be represented on the clipboard, after augmentation, using more than one type of clipboard data format. For example, with some clipboard systems on some operating systems, at various times, including before or after augmentation, a particular clipboard data item may have data in a text format—perhaps denoted using an identifier like CF_TEXT—and may also have data in other data formats with identifiers like CF_HTML, and so on. In these implementations, or in other implementations, it may be possible to use, for example, a data format that is defined for or associated with something like a container format like that described below with reference to FIG. 4. Such a data format might use an identifier like CF_LIVECLIPBOARD, or some other identifier. In such cases, or in other cases, one type of augmented data that may be identified might include a representation of the data placed on the clipboard, but in the data format defined for or associated with the container format. In just one specific example, the data originally placed on the clipboard might be text, perhaps identified using CF_TEXT, that contains XML that conforms to the container format described below with reference to FIG. 4. In this case, at least some of the augmented data might include the same XML data, but identified using the CF_LIVECLIPBOARD data format. Augmented data like this might be useful for a variety of reasons, including because it might be able to hold additional information, like perhaps an identification of the entity that pasted the original data, that may in some implementations not be represented using, for example, the initial data in the text data format.

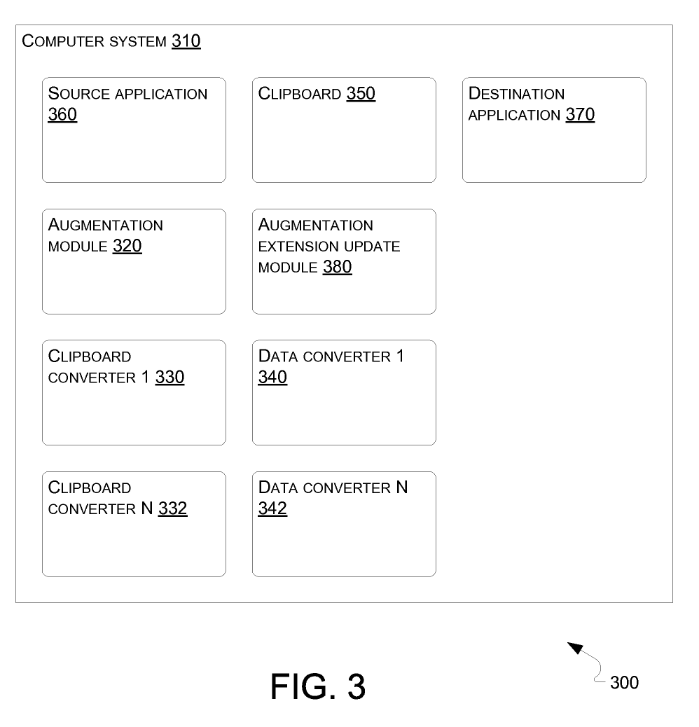

In some implementations, for at least some data formats, such executable code may be provided as an inherent part of the application, system, or the like, that is performing the augmentation. In the same or other implementations, for at least some data formats, such executable code may be logically separated from the system performing the clipboard augmentation. That is, for example, the immediate augmentation system might contain executable instructions to call out to other executable code that actually identifies the augmentation data. In at least some of such implementations, the separation of the augmentation system's “organizing” code from the code that does the actual identification of augmented data may enable the data formats supported by the augmentation system to be extended and changed. In some implementations, such extensions may be implemented using augmentation extensions like those described below, for example, with reference to operation 140. In the same or other implementations, such extensions may use “clipboard converters,” “data converters,” and augmentation extension update modules like those described in more detail below, for example, with reference to FIG. 3. In other implementations, such extensions may be implemented differently.

In an exemplary implementation of operation 130, the augmented data previously identified, for example, in operation 125, may be added to the clipboard in some fashion. In some cases the implementation of this operation may consist of using a clipboard interaction application programming interface (API) provided by the clipboard system to add new data.

In some cases this operation may also include additional processing to ensure that the data that is added to the clipboard is available in a format that may be usable by a destination. For example, a particular PIM application may understand data provided, for example, in vCard format. However, it may not understand vCard data that is added to the clipboard as text. Instead, it may require that the vCard data is saved to a file, and that a reference to the file be provided on the clipboard instead. In a situation like this, or in another situation where the data must be provided in a particular format requiring further processing, this step may perform such processing. In this example, the operation might save the vCard data to a file and specify the name and location of the newly created file in the data that it adds to the clipboard. In other implementations, such processing may be performed in other operations—for example, it might be performed as part of operation 125, when the augmented data is identified.

Finally, in an exemplary implementation of operation 135, the data added to the clipboard may be pasted into an application or other entity that may accept data pasted from the clipboard.

In at least some implementations, the operational flow may proceed to operation 140 when it is initially determined that the data cannot be augmented. This determination might be made, for example, by operation 120. Such a determination may indicate, for example and in some cases, that the data placed on the clipboard cannot, at the time operation 120 is executed, be recognized or understood by the clipboard augmentation process. For example, the data placed on the clipboard may comprise a contact, with name, email, phone number, and so on, but be in a format that is not recognized or understood to be a contact. In the same or other implementations, the data or data format of the data placed on the clipboard may be understood, but one or more desired augmented data formats may not be identified by the augmentation process for the particular data placed on the clipboard. For example, the data placed on the clipboard may be recognized as a contact in a particular format, but the clipboard augmentation process may not be able to generate augmented data in some other requested contact format.

Rather than complete the operational flow without augmenting the data placed on the clipboard, in some implementations operation 140 may be executed to possibly extend the capability of the clipboard augmentation process to use new or changed data formats. That is, the clipboard augmentation process may be extended in some cases to understand new or changed input formats, or to have the ability to identify augmented data in new or changed augmented data formats.

This extension may be accomplished by retrieving one or more “augmentation extensions.” As used herein, an “augmentation extension” comprises any information necessary to enable augmentation to be performed on data that uses a particular data format that may not—before the augmentation extension is applied—be recognized or understood. For example, before the retrieval and application of an augmentation extension, an operational flow like the operation flow of FIG. 1 may not have been able to augment data placed on the clipboard if the data included contact information in a particular format. After the application of an augmentation extension associated with a previously unsupported format, such data may be augmented. An augmentation extension may also comprise any information necessary to enable the identification of augmented data in some format that may not have been identified before the application of the augmentation extension. For example, given a particular supported format for data placed on the clipboard, the operational flow may not have been able to identify augmented data in some other new or changed format. However, after applying a particular augmentation extension, the operational flow may have the ability to identify augmented data in that new or changed format. Furthermore, an augmentation extension may also enable the identification of particular types of augmented data from particular types of input data, where such a link between input and augmented data was not supported before the application of the augmentation extension. For example, the operational flow might have recognized some particular input format and had the capability to produce some other augmented data format when presented with that particular data format. After the application of one or more augmentation extensions, the operational flow may be able to, for example, identify augmented data in additional and previously unsupported formats.

In some implementations, an augmentation extension may be the same as or similar to the “clipboard converters” and/or “data converters” discussed in more detail below, with reference to FIG. 3. In other implementations, augmentation extensions may include additional information beyond that defined by, for example, a clipboard converter or data converter. In yet other implementations, augmentation extensions may be different from clipboard converters and data converters.

In at least some implementations of operation 140, one or more augmentation extensions may be retrieved. Such retrieval may be performed in a number of different ways. For example, in some implementations the clipboard augmentation process may query some type of store or repository, or a set of multiple stores or repositories, where the stores or repositories hold or provide access to augmentation extensions. The clipboard augmentation process may query such stores or repositories to determine if some particular type of data may be augmented by augmentation extensions that are accessible to the store or repository. For example, the store or repository might in some implementations comprise a database of augmentation extensions. Such a database might be accessible locally or remotely (over a network, for example) using, as just some examples, database-specific APIs, one or more web service interfaces, or any other type of interaction mechanism. The clipboard augmentation process may provide as part of a query, for example, type information associated with the data that was placed on the clipboard, type information associated with desired output or augmented data formats, and so on. In such an example, or in other implementations, if the store or repository contains augmentation extensions that enable the identification of augmented data when presented with the specified type information, or the identification of augmented data of the presented type or types, the store or repository might provide or make accessible such augmentation extensions. The augmentation extensions might then be retrieved as part of operation 140.

In just one specific example, an augmentation extension might comprise, for example, an XSLT transform specification or executable code that performs a particular augmentation. In such a case, the transform specification or code may be made accessible by a store or repository and then retrieved and made available for use as part of the clipboard augmentation process. For example, the transform specification or executable code may be downloaded from the store or repository and stored locally or remotely by the clipboard augmentation process. The clipboard augmentation process may also update, for example, its configuration data so that such augmentation extensions are not retrieved in the future (as they have already been retrieved), and may perform other operations.

In some implementations, a store or repository of augmentation extensions may be accessible by only particular entities—for example, it might be accessible only by an entity, like a company or organization, that maintains the augmentation system. In other implementations, a store or repository may be maintained by one entity and may be accessible by a wide variety of additional entities, including entities not controlled or closely associated with the maintaining entity. For example, a company might make a repository available on a network like the Internet, perhaps as a web site or web service, and enable other companies, individuals, entities, and so on, to submit augmentation extensions. When some other company creates or starts using some new data format, the other company may be able to provide augmentation extensions associated with that new data format to the repository, and in doing so, enable users of the augmentation system to copy and paste data that uses the new data format, all perhaps without explicit work or perhaps approval on the part of the entity that maintains the augmentation system and store or repository.

In some implementations, after any available or relevant augmentation extensions have been retrieved, the operational flow may proceed to operation 145. In operation 145 it may be determined if the data placed on the clipboard may be augmented, perhaps in some cases similar to the previously described operation 120. If the data can be augmented, the operational flow may proceed to operation 125, where the augmented data may be identified. If the data cannot be augmented, even after available augmentation extensions have been considered or retrieved, then the operational flow may end.

While in some implementations the examination and retrieval of one or more augmentation extensions may be performed as a result of an (initial) determination that a particular data format is not recognized or understood or that a particular augmented data format may not be generated, as described previously, in other cases augmentation extensions may be examined, retrieved, and so on, at other times and in other fashions. For example, in some implementations a scheduled process or task may exist that periodically retrieves any new or changed augmentation extensions. Such a process may exist and execute independently of any particular data placed on a clipboard. For example, the process may execute every day at a particular pre-defined time, independent of what data has been or is placed on the clipboard.

Furthermore, when augmentation extensions are examined or retrieved, in some cases only augmentation extensions that may be related to, for example, a particular request for augmentation, may be retrieved, while in other cases any new, updated, changed, or otherwise notable augmentation extensions may be retrieved.

Generally, as used herein, a “clipboard” or “clipboard system” should be interpreted as an entity that provides functionality associated with the transfer of data between different entities, including, for example, between different applications, web pages, and so on. Some of such computer-implemented clipboard systems may provide the capabilities of adding data to a clipboard—perhaps associated with a copy or cut operation—and reading data from a clipboard—perhaps associated with a paste operation. The same or other clipboard systems may provide the ability to hold multiple pieces of data, or items, at the same time. Furthermore, the same or other clipboard systems may provide the ability to hold multiple representations or formats for a particular data item. For example, a clipboard system might have the ability to hold, say, a formatted text, plain text, and image representation of the same item. The same or other clipboard systems may enable a destination application to use or request a particular format or representation of an item. For example, a word processing application might use the formatted text representation, a simple text editor the plain text representation, and an image processing application the image representation.

It should also be noted that, as used herein in the context of transferring information, the term “copy” may also include a “cut” operation, where the difference may be that data associated with a copy operation may remain in the location from which it is being copied. In contrast, data being “cut” may be removed or hidden, through some means, from the location from which it is being copied. In both copy and cut operations, data may be placed on the clipboard—the difference may be in what happens at the location from which the data is copied or cut.

Finally, it should be noted that in some implementations cut, copy, and paste operations may be performed through multiple different user interface actions. For example, a user may initiate a copy operation using a “Copy” menu item, using a keyboard command like “Control-C,” or some other command, and so on. In some embodiments, a user may also employ one or more of a variety of other actions, such as “drag and drop” gestures. For example, a user may select, indicate, or otherwise identify some data to be copied or cut by, say, selecting the data using computer mouse movements, and then initiate a copy or cut operation by “dragging” the selected entity or data to some other location—perhaps by clicking and holding a mouse button, and then finally “drop” the entity to initiate a paste operation at the indicated location. As used herein, copy, cut, and paste operations should be considered to encompass any set of user actions or gestures, including those associated with such drag and drop systems.

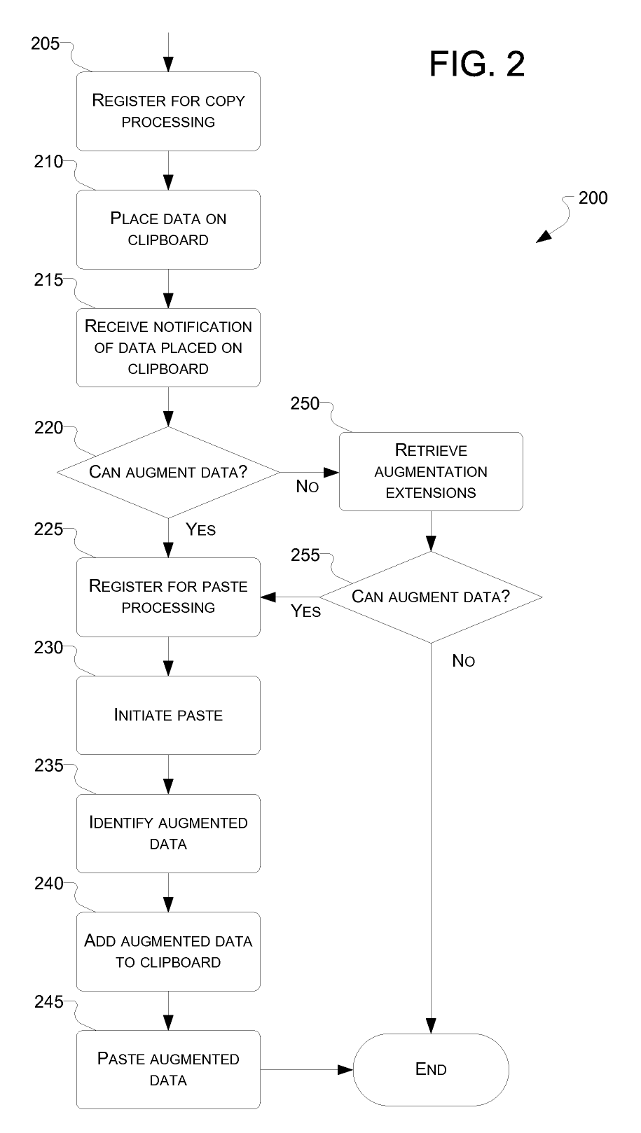

Turning now to FIG. 2, shown therein is an exemplary generalized operational flow 200 including various operations that may be performed when augmenting data on a clipboard using “delayed rendering” and extending the augmenting of data on the clipboard, where the identification of the augmented data may only be performed in some cases when the data is needed during a paste operation. The following description of FIG. 2 may be made with reference to other figures. However, it should be understood that the operational flow described with reference to FIG. 2 is not intended to be limited to being used with the elements described with reference to these other figures. In addition, while the exemplary operational flow of FIG. 2 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

In summary, the operational flow 200 may be similar to or the same as the operational flow 100 in many respects, but differs in how the augmented data is added to the clipboard such that the augmented data may only be added to the clipboard when it is needed, for example, to service a paste operation. For example, suppose that part of the augmentation process for a particular type of input data requires that a reference on the clipboard be resolved and the data to which the reference refers be identified. For example, this might be the case where a URL to an image is augmented by retrieving the actual image and adding the image itself to the clipboard, or by saving the image to a file and adding a reference to the file to the clipboard. Depending on the size of the image, the characteristics of the network connection to the server or servers on which the image resides, and so on, identifying the augmented data by retrieving the image may take a non-negligible amount of time. In a situation like this, or in other situations, it may be desirable to avoid identifying the augmented data until, for example, one is sure that the augmented data will be used, pasted, or the like. The operational flow 100 described previously with reference to FIG. 1 does not do this, as it may identify the augmented data at close to the same time as the original data is placed on the clipboard.

In some implementations, operation 205 may be similar to the previously discussed operation 105, operation 210 to the previously discussed operation 110, operation 215 to the previously discussed operation 115, and operation 220 to the previously discussed operation 220. In other implementations, these operations may be different.

Continuing, after it is determined that the data added to the clipboard may be augmented, in an exemplary implementation of operation 225 the operational flow may register for paste processing. In general, this may involve registering for further processing in at least some situations. For example, a clipboard system may provide the ability to call back to a provided function when a user requests that data of a particular type be pasted. In an implementation like this, and continuing with the example where the augmented data requires the download of an image, for example, it may be possible to register to receive a callback when a user initiates a paste and requests an image. When a destination requests an image during a paste operation, the clipboard system or other executable code may call the registered function or functions, and the function may perform any necessary processing to, in this example, download the image and place it on the clipboard. In other implementations, registering for paste processing may involve different or additional steps.

After registering for paste processing, some implementations of the operational flow 200 may not execute any further operations until the point at which a paste operation is initiated that necessitates the further processing for which the registration was submitted, for example, in operation 225. So, in at least one exemplary implementation of operation 230, a paste operation is initiated. For example, in some cases this paste operation may be for a format or formats for which further processing was requested in operation 225. The paste operation may be initiated in a variety of ways, including by using a “Paste” menu item associated with a destination application, by pressing a keyboard command associated with paste—like “Control-V”—and so on.

Now that further processing has been requested, operation 235 and operation 240 may be executed to identify and add the augmented data to the clipboard, and then operation 245 may be executed to paste that data into a destination application. In some cases, the implementations of operation 235, operation 240, and operation 245 may be the same as or similar to the implementation of the similar operations described previously with reference to FIG. 1. That is, operation 235 may be implemented similarly to the previously described operation 125, operation 240 may be implemented similarly to the previously described operation 130, and operation 245 may be implemented similarly to the previously described operation 135. In other implementations, these operations may be implemented differently. Similarly, the implementations of operation 250 and operation 255 may be the same as or similar to the implementations of the similar operation 140 and 145 described previously with respect to FIG. 1. In other implementations, these operations may be implemented differently.

Turning now to FIG. 3, shown therein is an exemplary system 300 in which clipboard augmentation and augmentation extension may be performed. The exemplary system 300 may contain a computer system 310, a source application 360, a clipboard 350, a destination application 370, an augmentation module 320, an augmentation extension update module 380, a clipboard converter 1 330, a clipboard converter N 332, a data converter 1 340, and a data converter N 342. This description of FIG. 3 may be made with reference to other figures. However, it should be understood that the elements described with reference to FIG. 3 are not intended to be limited to being used with the elements described with reference to other figures. In addition, while the exemplary diagram in FIG. 3 indicates particular elements, in some implementations not all of these elements may exist, and in some implementations additional elements may exist. Furthermore, while the exemplary diagram shows elements as being part of or contained by a particular computer system, for example, it should be noted that one or more modules may also be implemented by one or more other computer systems and connected to the exemplary illustrated computer system by any means sufficient for exchanging any necessary data.

The exemplary augmentation module 320 may be configured in at least some implementations to perform some or all of the steps introduced previously with respect to the operational flow 100 of FIG. 1 and operational flow 200 of FIG. 2. That is, for example, the augmentation module may be configured to “watch” or be notified when information is added to the clipboard 350 and, when information is added, to in some cases augment the information with additional information.

The source application 360 may be any application or other entity that is capable of placing data on the clipboard 350. The source application may do so in a variety of ways, including through the use of operating system functionality or user interface controls that provide access to the clipboard, through the use of clipboard APIs, and so on. The destination application 370 may similarly be any application that is capable of accepting data from the clipboard 350, perhaps using a paste operation. The destination application may accept information using user interface controls, clipboard APIs, and so on.

The clipboard 350 may represent a clipboard system provided by the operating system, by one or more applications, or by any other entity. As has been discussed previously, a clipboard system like the clipboard system 350 may generally be capable of accepting data (using a “copy” or “cut” operation, for example) and providing data (using a “paste” operation, for example). Some clipboard systems may be capable of interacting across applications on a particular computer system or computing device, others may be capable of operating across computer systems running the same or different operating systems, others may only operate across instances of a particular application or applications, and so on. Furthermore, as also has been discussed previously, clipboard systems may provide a variety of additional functionality, including the capability of storing a particular data item using multiple different formats, or the capability of performing delayed rendering, where the addition of data to the clipboard may be postponed, for example, until the time particular data is requested.

The augmentation module 320 may in some implementations use one or more clipboard converters, including clipboard converter 1 330 and clipboard converter N 332. Generally, a clipboard converter may be capable of converting one or more particular types of input into one or more particular types of output. For example, an hCard-to-vCard clipboard converter might convert hCard data to the vCard format (after which the augmentation module might add the augmented vCard data to the clipboard). A clipboard converter may produce its output data using a transform specification, arbitrary executable code, or other mechanisms, for example.

In some implementations, a clipboard converter may further be responsible for additional processing that may be required or useful in particular environments, operating systems, with particular applications, or the like. That is, a clipboard converter may also perform “platform-dependent” processing that may be useful on a certain platform or in a certain environment or environments. For example, if a particular PIM application requires that contact data in the vCard format be provided as a reference to a file (instead of, for example, simply as text on the clipboard), then a clipboard converter may save the converted vCard data to a file and add a reference to that file to the clipboard.

This difference between platform-independent processing and platform-dependent processing may in some implementations be related to the use of one or more data converters, such as data converter 1 340 and data converter N 342. Generally, a data converter may be responsible for producing data in one or more formats given input data in one or more other formats. A data converter may generally not be responsible for performing platform-dependent processing, and in this case, such platform-dependent processing may then may be left to a clipboard converter that uses a particular data converter. For example, using the previously presented example where the input is contact data in the hCard format and the desired output is a file that contains vCard data, a clipboard converter may receive the input hCard data, may then use a data converter to convert from the hCard representation to a vCard representation, and may then save the converted vCard data produced by the data converter to a file and add a reference to the new file to the clipboard.

The augmentation extension update module 380 may be configured in at least some implementations to perform some or all of the operations associated with retrieving augmentation extensions and introduced and described previously with reference to FIG. 1 and FIG. 2. For example, in some implementations, the augmentation extension update module may perform all or part of operation 140 of FIG. 1 and operation 250 of FIG. 2. It may do so in some implementations by retrieving one or more clipboard converters and data converters, like clipboard converter N 332 and data converter N 342. In other implementations, the augmentation extension update module may represent augmentation extensions as other types of data and code. In some implementations, the augmentation extension update module may be part of the same application, system, or the like, as, for example, the augmentation module 320, while in other implementations, the augmentation extension update module may exist as or as part of a separate application, system, or the like.

While it may be possible to identify multiple pieces of augmented data using, for example, a single augmentation module 320 and one or more clipboard converters, it may also be possible in some implementations to identify multiple pieces of augmented data using more than one augmentation module 320. For example, the augmentation module 320 might identify certain types or pieces of augmented data, while another augmentation module, perhaps implemented in another application, and not shown, might identify other types or pieces of augmented data. As just one specific example, an application that is separate from the shown augmentation module 320 might itself perform at least some of the operations described previously with reference to FIG. 1 or FIG. 2, and in doing so might also identify and add augmented data to the clipboard. Such augmented data might co-exist with the augmented data identified and added by other modules, including the augmentation module 320.

Turning now to FIG. 4, shown therein is an exemplary system 400 that includes a graphical example of one mechanism for representing clipboard data, including a transfer representation of data. The exemplary system may contain clipboard data 410, structured data 420, feed data 450, and presentation data 480. Any or all of the structured data, feed data, and presentation data may include references in at least some implementations. Structured data may be associated with one or more structured data formats, such as structured data format 1 430 and structured data format N 432. A structured data format may contain one or more items, such as item 1 434 and item N 436. Feed data may be associated with feeds like feed 1 460 and feed N 462, while a feed may be associated with some number of sets of feed items, such as feed items 1 464 and feed items N 468. A set of feed items, like feed items 1 464, may be associated with some number of feed items, like feed item 1 466 and feed item N 467. Finally, presentation data 480 may be associated with one or more presentation formats, like presentation format 1 490 and presentation format N 492. This description of FIG. 4 may be made with reference to other figures. However, it should be understood that the elements described with reference to FIG. 4 are not intended to be limited to being used with the elements described with reference to other figures. In addition, while the exemplary diagram in FIG. 4 indicates particular elements, in some implementations not all of these elements may exist, and in some implementations additional elements may exist.

Clipboard data may be represented in a wide variety of formats. In some implementations, clipboard data may include some structured representation of the data itself (which may itself include references to additional data), feed or subscription information that may be associated with one or more references to additional data and about the structured data or about other data, and additional presentation or display representations of the structured data.

In some implementations, clipboard data, such as the clipboard data 410, may be represented using a markup language, like XML, for example, or some other representation. It should be noted that while the system 400 and the clipboard data 410 may be described herein with reference to XML elements, XML attributes, and so on, the use of XML is not required and any description of such use herein is provided for exemplary purposes only. The clipboard data may be represented in any number of a wide variety of alternate formats. Furthermore, while particular elements, attributes, and so on, may be referred to for exemplary purposes using a particular name, such elements, attributes, and so on, may be referred to using any name.

In some implementations, the clipboard data 410 may contain header information as well as one or more of different types of data, including the actual structured data, feed data, and presentation data. In general each of these types of data may refer to the same information, but in different formats. One purpose of providing multiple formats in this manner may be to make it more likely that a destination may find data appropriate for its use.

When represented using a markup language, perhaps like XML, the structure of the clipboard data 410 might be the same as or similar to the following:

| | |
|---|---|
| <liveclipboard> | |
| <lc:data> | 0 or 1 elements |
| <lc:format> | 1 or more elements |
| <lc:item/> | 1 or more elements |
| </lc:format> | |
| </lc:data> | |
| <lc:feeds> | 0 or 1 elements |
| <lc:feed> | 1 or more elements |
| <lc:feeditems> | 0 or 1 elements |
| <lc:feeditem> | 0 or more elements |
| </lc:feeditems> | |
| </lc:feed/> | |
| </lc:feeds> | |
| <lc:presentations> | 0 or 1 elements |
| <lc:format/> | 1 or more elements |
| </lc:presentations> | |
| </liveclipboard> | |

In some implementations, the “liveclipboard” element may be associated with the clipboard data 410, and the “data”, “feeds”, and “presentations” elements, and their child elements, may be associated, respectively, with the structured data 420, feed data 450, and presentation data 480, and their child elements, as described with reference to FIG. 4. In addition, in this example data, the use of the string “Ic:” might indicate a particular XML namespace, perhaps including a namespace related to transferring structured data using a clipboard as described herein.

In some cases, header or other information may be associated with the clipboard data 410. This data may be associated with some or all of “version”, “source”, and “description” attributes, as well as other attributes. The “version” attribute may represent the version of the clipboard data format used in a particular instance of the clipboard data. The “source” attribute may represent a reference, like a URL, to the source provider of the clipboard data content. And the “description” attribute may represent a human readable description of clipboard data content.

In some implementations, the clipboard data may be associated with at least one of structured data 420, feed data 450, and presentation data 480. In the same or other implementations, the clipboard data may be associated with more than one of these elements, including some implementations where all three of the elements, or possibly other elements, may be included.

The first set of data that may be included is the structured data itself, which, in some implementations, may be associated with the structured data 420. In the same or other implementations the structured data 420 may be associated with data represented using defined data formats, such as hCard and vCard for representing contact information, hCal and iCal for representing event information, and so on. However, any defined format or structured data may be used or associated with the structured data 420.

When the clipboard data 410 contains structured data 420, it may be represented, for example, in a manner similar to or the same as the following:

| | |
|---|---|
| <lc:data> | 0 or 1 elements |
| <lc:format> | 1 or more elements |
| <lc:item/> | 1 or more elements |
| </lc:format> | |
| </lc:data> | |

When represented like this, the “format” element may correspond to the structured data format 1 430 and the structured data format N 432, while the “item” element may correspond to the item 1 434 and the item N 436.

A structured data format, like structured data format 1 430, may define the format of the child “item” elements, like item 1 434 and item N 436, with which it is associated. A structured data format may be associated with some or all of the “contenttype”, “type”, and “encoding” attributes, as well as other attributes. The “contenttype” attribute may represent the content type of data for the contained “item” elements. For example, this attribute may contain data defined by the Internet Assigned Names Association (IANA), like “text/calendar”, “application/xhtml+xml”, and so on. The “type” attribute may represent a schema or format type of the data for the contained “item” elements. This may be useful, for example, if an IANA format identifier provided may not be sufficient to completely determine the type. For example, when the “contenttype” attribute has a value of “text/calendar” there may be sufficient information to determine that the data associated with an “item” element is formatted using the iCal standard. In contrast, when the “contenttype” attribute has a value such as “application/xhtml+xml”, additional information may be necessary to determine the format of the data in the “item” element. For example, in this case, the “type” attribute might have a value of “vevent”, which might indicate that the data is formatted using the hCal standard. Finally, an “encoding” attribute may represent how the data associated with the “item” elements is encoded.

In some implementations, when multiple formats are provided, such as with multiple instances of structured data format 1 430 and structured data format N 432, it may be useful to order the formats in some fashion. For example, “higher fidelity” formats—formats that may provide more data, for example—might be ordered before “lower fidelity” formats that do not provide as much data. (Lower fidelity formats may be more widely accepted by destinations, and so still may be preferable for some uses, or for some applications, web pages, and so on.)

After the format of the data is defined, for example, using a structured data format, like structured data format 1 430, one or more items that are represented using that format may be provided. These items may correspond, for example, to the item 1 434 and item N 436. In some representations, these items may be associated with “item” elements that are perhaps located as children of “data” and “format” elements.

An “item” may represent data itself and may be associated with some or all of “description” and “ref” attributes, as well as other attributes. The “description” attribute may represent additional data defined by the user or application. The “ref” attribute may contain a reference, for example a URL, associated with the item.

The “item” element may also contain data itself. For example, when using XML, if the data can be represented as well-formed XML data that uses, say, the UTF-8 encoding, then the XML corresponding to the data may be appended as a child of the “item” element. In some other cases, for example when the data may not be represented as well-formed UTF-8 XML data, the data may reside in a CDATA section for the “item” element, optionally encoded in the format described by the “encoding” attribute of the enclosing “format” element.

Data associated with either or both of the “format” and “item” elements may include both “by-value” and “by-reference” data. That is, the actual data itself may be included, for example, in the “item” element. Alternatively, or in addition to the actual data, a reference to the data or to additional data may be included. That is, an “item reference” may be included in the data for a structured data item. In some implementations, for example, the reference to the data may be stored using the previously introduced “ref” attribute. For example, in an item that contains information about a single contact or person, a by-value copy of the data might be provided as part of the “item” element itself, and a reference to that contact—perhaps as a URL—might be provided using the “ref” attribute of the “item” element. In some cases, for a particular item, only by-value data may be provided, while in other cases only by-reference data may be provided, and while in yet other cases, both by-value and by-reference data may be provided.

In some implementations, when there are multiple structured data formats, the ordering of items beneath each format may indicate how items correspond to each other. For example, if clipboard data 410 includes two structured data formats X and Y, corresponding in some implementations to two “format” elements, the first “item” element of format X may correspond to the first “item” element of format Y. That is, the first “item” element for each format may refer to the same item, but represented in different formats. Furthermore, in some implementations, when feed data—discussed in more detail below—exists, including feed data that includes feed items, the ordering of “item” elements may correspond to the ordering of “feeditem” elements, which may enable the correspondence of items to their location in a feed.

As just one example, suppose that the clipboard data includes contact information for a particular contact, and that the contact information itself is represented using the hCard standard. In such an example, the contact information itself may be represented as follows:

```
<div class=‘vcard’>
    <span class=‘fn n’>
    <span class=‘given-name’>John</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
```

A corresponding clipboard data representation might consist of the following data:

```
<?xml version=“1.0” encoding=“utf-8”?>
<liveclipboard version=“0.92”
xmlns:lc=“http://www.microsoft.com/schemas/liveclipboard”>
  <lc:data>
    <lc:format type=“vcard” contenttype=“application/xhtml+xml”>
      <lc:item>
        <div class=‘vcard’>
          <span class=‘fn n’>
            <span class=‘given-name’>John</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
    </lc:format>
  </lc:data>
</liveclipboard>
```

As another example, suppose that two contacts—each represented using hCard—are to be represented as clipboard data. The contacts themselves might be represented as follows:

```
<div class=‘vcard’>
  <span class=‘fn n’>
    <span class=‘given-name’>John</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
<div class=‘vcard’>
  <span class=‘fn n’>
    <span class=‘given-name’>George</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
```

And the corresponding clipboard data representation might be as follows:

```
<?xml version=“1.0” encoding=“utf-8”?>
<liveclipboard version=“0.92”
xmlns:lc=“http://www.microsoft.com/schemas/liveclipboard”>
  <lc:data>
    <lc:format type=“vcard” contenttype=“application/xhtml+xml”>
      <lc:item>
        <div class=‘vcard’>
          <span class=‘fn n’>
            <span class=‘given-name’>John</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
      <lc:item>
        <div class=‘vcard’>
          <span class=‘fn n’>
            <span class=‘given-name’>George</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
    </lc:format>
  </lc:data>
</liveclipboard>
```

As discussed previously, the clipboard data may include alternate representations or formats for a single item. As one example, suppose that an event may be represented using both the iCal and hCal standards. With such an example, the iCal data might be like the following:

BEGIN:VCALENDAR
METHOD:PUBLISH
VERSION:2.0
BEGIN:VEVENT
URL:http://www.microsoft.com/events/E1-001-000629872-2
DTSTART:20060208T180000
DTEND:20060208T180000
DTSTAMP:20060119T184157Z
SUMMARY:The Bellevue Vegetarian February Meetup
DESCRIPTION:Let's all get together and meet over a great veggie dinner
at Teapot
Vegetarian House in Redmond!
UID:E1-001-000629872-2
LOCATION:Bellevue\,Washington 98004
END:VEVENT
END:VCALENDAR

In the same example, the corresponding hCal data might be like the following:

```
<div class=‘vevent’>
  <a class=‘url’ href=‘http://www.microsoft.com/events/
  E1-001-000629872-2’>
    <span class=‘summary’>The Bellevue Vegetarian February
    Meetup</span>
  </a>
    <div class=‘description’>Let&#39;s all get together and meet over a
great veggie dinner at Teapot Vegetarian House in Redmond!</div>
    <div>Start Date: <abbr class=‘dtstart’
    title=‘20060208T180000’>February 8,
2006</abbr></div>
    <div>End Date: <abbr class=‘dtend’
    title=‘20060208T180000’>February 8,
2006</abbr></div>
    <div>Location: <span class=‘location’>Bellevue,Washington 98004</
    span></div>
    <div>UID: <span class=‘uid’>E1-001-000629872-2</span></div>
    <div>Last Updated: <abbr class=‘dtstamp’
    title=‘20060119T184157Z’>January 19,
2006</abbr></div>
</div>
```

Both of these formats might be represented in clipboard data in a manner similar to or the same as the following:

```
<?xml version=“1.0” encoding=“utf-8” ?>
<liveclipboard version=“0.92”
xmlns:lc=“http://www.microsoft.com/schemas/liveclipboard”>
  <lc:data>
    <lc:format type=“vcalendar” contenttype=“application/xhtml+xml”>
      <lc:item>
        <div class=‘vevent’>
          <a class=‘url’ href=‘http://www.microsoft.com/events/E1-001-000629872-2’>
            <span class=‘summary’>The Bellevue Vegetarian February Meetup</span>
          </a>
          <div class=‘description’>Let&#39;s all get together and meet over a great veggie
dinner at Teapot Vegetarian House in Redmond!</div>
          <div>Start Date: <abbr class=‘dtstart’ title=‘20060208T180000’>February 8,
2006</abbr></div>
          <div>End Date: <abbr class=‘dtend’ title=‘20060208T180000’>February 8,
2006</abbr></div>
          <div>Location: <span class=‘location’>Bellevue,Washington 98004</span></div>
          <div>UID: <span class=‘uid’>E1-001-000629872-2</span></div>
          <div>Last Updated: <abbr class=‘dtstamp’ title=‘20060119T184157Z’>January 19,
2006</abbr></div>
        </div>
      </lc:item>
    </lc:format>
    <lc:format contenttype=“text/calendar”>
      <lc:item>
        <![CDATA[
          BEGIN:VCALENDAR
          METHOD:PUBLISH
          VERSION:2.0
          BEGIN:VEVENT
          URL:http://www.microsoft.com/events/E1-001-000629872-2
          DTSTART:20060208T180000
          DTEND:20060208T180000
          DTSTAMP:20060119T184157Z
          SUMMARY:The Bellevue Vegetarian February Meetup
          DESCRIPTION:Let's all get together and meet over a great veggie dinner at Teapot
Vegetarian House in Redmond!
          UID:E1-001-000629872-2
          LOCATION:Bellevue\,Washington 98004
          END:VEVENT
          END:VCALENDAR
        ]]>
      </lc:item>
    </lc:format>
  </lc:data>
</liveclipboard>
```

Some clipboard data representations may be associated with subscription or feed information that may be, in some implementations, associated with the feed data 450. Such information may be useful, for example, to transfer references to data, to represent feeds of data, to enable subscriptions to data or feeds, and so on. In one example, item data may be provided using, for example, the structured data 420, and information about a feed that may be used to update the item data may be provided using the feed data 450. For example, an initial set of contacts might be provided using the structured data 420, and information in the feed data 450 may be provided to enable an application to later update the contacts initially provided using the structured data. In another example, the feed data may refer to some other data or information—that is, for example, the feed data may refer to data that is not transferred in the structured data 420. For example, the feed data may refer to one or more RSS (“Really Simple Syndication” or “Rich Site Summary”), Atom, or other feeds that contain additional or other information. The information referred to by the feed data may be related to or associated with the data included elsewhere in the transfer or clipboard data representation or may refer to data that is not included or associated with the transfer or clipboard data representation. Note also that references may be represented and communicated in other fashions that do not use feed references in feed data. For example, a reference might be represented as an item reference in a structured data item, as has been described previously.

Feed data may be represented in multiple ways, including, for example, in a manner similar to the following:

| | |
|---|---|
| <lc:feeds> | 0 or 1 elements |
| <lc:feed> | 1 or more elements |
| <lc:feeditems> | 0 or 1 elements |
| <lc:feeditem> | 0 or more elements |
| </lc:feeditems> | |
| </lc:feed/> | |
| </lc:feeds> | |

When represented like this, the “feeds” element may correspond to the feed data 450, the “feed” element may correspond to the feed 1 460 and feed N 462, the “feeditems” element may correspond to the feed items 1 464 and feed items N 468, and the “feeditem” element may correspond to the feed item 466 and feed item N 467.

A feed, like feed 1 460 and feed N 462, may have associated information about the feed. A feed may be associated with some or all of the “type”, “ref”, “description”, and “authtype” attributes, as well as other attributes. The “type” attribute may represent the type of data that exists at the location specified, for example, by the “ref” attribute. For example, the “type” attribute may include values such as “RSS”, “Atom”, and so on, or other values. Generally, a wide variety of feed types may be used, depending upon, for example, the capabilities of the endpoints. For example, some implementations may support RSS, other implementations may support RSS and also support extensions to RSS to implement other functionality, and so on. For example, some endpoints may support “Simple Sharing Extensions” to enable bi-directional synchronization of data using RSS or other feed types. The “ref” attribute may represent a specific reference or address associated with the feed, like a URL. In some implementations, this reference may be the location of the feed itself. The “description” may represent some user-specified data associated with the feed. Finally, the “authtype” attribute may represent some type of authentication technique or techniques that may or must be used when accessing the feed.

Each feed may contain some number of sets of feed items, such as feed items 1 464 and feed items N 468. These may be represented in some cases by one or more “feeditems” elements. In turn, a set of feed items may contain some number of feed items, which might be represented using “feeditem” elements.

A set of feed items may be associated with the “contenttype”, “type”, and “xpath” attributes, as well as other attributes. The “contenttype” attribute may represent the content type of data for the contained “feeditem” elements. For example, similar to the structured data, this attribute may contain data defined by IANA, like “text/calendar”, “application/xhtml+xml”, and so on. The “type” attribute may represent a schema or format type of the data for the contained “feeditem” elements. This may be useful, like before and for example, if an IANA format identifier provided may not be sufficient to completely determine the type. For example, when the “contenttype” attribute has a value of “text/calendar” there may be sufficient information to determine that the data associated with a “feeditem” element is formatted using the iCalendar standard. In contrast, when the “contenttype” attribute has a value such as “application/xhtml+xml”, additional information may be necessary to determine the format of the data in the “feeditem” element. For example, in this case, the “type” attribute might have a value of “vevent”, which might indicate that the data is formatted using the hCal standard.

The “xpath” attribute may represent a query—perhaps using the XPath standard, but also represented using some other query language or standard—that returns or otherwise identifies data items from the feed. For example, if a feed is retrieved using the “ref” attribute of the parent “feed” element, in some cases the query represented by the “xpath” attribute may be executed against the contents of the retrieved feed to identify particular data items in the feed. This may enable the feed to contain a variety of data, only some of which may be relevant for or associated with the clipboard data, and still enable the clipboard data to be associated directly with the relevant data. In addition, this may enable the relevant portions of the data to be changed, perhaps at some later time, by only changing the value of this attribute; the actual data in the feed would not necessarily need to change. In implementations that do not use the “xpath” attribute, or a similar type of attribute or query, all of the data associated with the feed may be relevant to, for example, a subsequent update or data retrieval operation.

Similar to with the structured data discussed previously, in some implementations, when multiple formats are provided, it may be useful to order the formats in some fashion. For example, “higher fidelity” formats—formats that may provide more data, for example—might be ordered before “lower fidelity” formats that do not provide as much data. As before, lower fidelity formats may be more widely accepted, and so still may be preferable for some uses, or for some applications, web pages, and so on.

A set of feed items may in turn be associated with or contain some number of “feeditem” elements, which may in some cases, enable information retrieved from the feed to be linked to “item” elements provided, for example, in the structured data 420. A “feeditem” element may be associated with an “id” attribute, or some other attribute or data, which may represent some type of identifier, perhaps a unique identifier, for the feed item. In implementations that do not use or include elements like the “feeditem” element, data may still be retrieved and used, but in some cases the data may not be linked to the structured data also provided with the clipboard data.

In at least some implementations, if there are multiple instances of feeds, like feed 1 460 and feed N 462, the ordering of “feeditem” elements beneath each feed may indicate that particular items correspond to each other. For example, in the case where there are two “feed” elements named X and Y, the first “feeditem” element associated with “feed” X may correspond to the first “feeditem” element associated with “feed” Y. Also, in clipboard data that has structured data 420, the ordering of “feeditem” elements may correspond to the ordering of “item” elements provided in the structured data 420.

An example clipboard data representation that uses feed data 450 is provided below, after the discussion of presentation data.

Finally, some clipboard data representations may be associated with presentation data, such as presentation data 480 and presentation format 1 490 and presentation format N 492. Such data may provide a formatted or display representation of data that may also be provided elsewhere in the clipboard data. For example, where the structured data 420 includes a contact, perhaps in the hCard or vCard formats, the presentation data may be associated with an instance of the same contact data represented using HTML, JPEG, or some other presentation data format. In many cases destination applications, web pages, or the like, that do not understand data in one or more structured data formats may still understand a display representation, like HTML or JPEG, and so may still be able to at least display or present the clipboard data.

Presentation may be represented in multiple ways, including, for example, in a manner similar to the following:

| | |
|---|---|
| <lc:presentations> | 0 or 1 elements |
| <lc:format/> | 1 or more elements |
| </lc:presentations> | |

When represented like this, the “presentations” element may correspond to the presentation data 480, and the “format” element may correspond to the presentation format 1 490 and presentation format N 492.

The presentation data 480 may be associated with some number of presentation formats. Each presentation format, perhaps represented by a “format” element, may be associated with some or all of the “contenttype”, “type”, “encoding”, “description”, and “ref” attributes, as well as other attributes. The “contenttype” attribute may represent the content type of data, for example, for a CDATA section associated with this format. For example, this attribute may contain data defined by IANA, like application/xhtml+xml”, and the like. The “type” attribute may represent a schema or format type of the data for the format. Like before, this may be useful, for example, if an IANA format identifier provided may not be sufficient to completely determine the type. The “encoding” attribute may represent how the data associated with, for example, a CDATA section is encoded. The “description” attribute may represent data defined by the user or application. Finally, the “ref” attribute may contain a reference, for example a URL, associated with the item.

Similar to with structured data, a “format” element may also contain data itself. For example, when using XML, if the data can be represented as well-formed XML data that uses the UTF-8 encoding, then the XML corresponding to the data may be appended as a child of the “format” element. In some other cases, for example when the data may not be represented as well-formed UTF-8 XML data, the data may reside in a CDATA section for the “format” element, optionally encoded in the format described by the “encoding” attribute.

As just one example, suppose clipboard data is desired that represents contact information in the hCard format, an RSS feed associated with the contact information—so the contact information can be updated at some later point in time, for example—and an HTML representation of the contact data—perhaps useful, for example, if a destination of the clipboard data does not understand the hCard format.

With such an example, the hCard contact data might be represented as follows:

```
<div class=‘vcard’>
  <span class=‘fn n’>
    <span class=‘given-name’>John</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
<div class=‘vcard’>
  <span class=‘fn n’>
    <span class=‘given-name’>George</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
```

In the same example, the RSS data might be represented as follows:

```
<?xml version=“1.0” encoding=“utf-8” ?>
<rss version=“2.0”>
  <channel>
  <title>My Friends </title>
  <link>http://localhost/FriendsFeed.ashx</link>
  <pubDate>Wed, 15 Mar 2006 09:05:43 -0800</pubDate>
  <lastBuildDate>Wed, 15 Mar 2006 09:05:43 -0800</lastBuildDate>
  <item>
  <title>John Doe</title>
    <description>
    <![CDATA[
      <div class=‘vcard’>
        <span class=‘fn n’>
          <span class=‘given-name’>John</span>
            <span class=‘family-name’>Doe</span>
            </span>
          <div class=‘adr’>
          <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’>98052</span>
          </div>
          <div class=‘tel’>
            <span class=‘type’>work</span>
            <abbr class=‘type’ title=‘voice’> phone: </abbr>
            <span class=‘value’>+1-425-555-1212</span>
          </div>
        </div>
      ]]>
    </description>
    <enclosure
url=“http://server/SIS/contact.vcf?puid=
1688852012477191&roid=4EB2576478DA9846A06EFCC12FFC0185”/>
  </item>
  <item>
    <title>George Doe</title>
    <description>
      <![CDATA[
        <div class=‘vcard’>
          <span class=‘fn n’>
            <span class=‘given-name’>George</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’>98052</span>
          </div>
          <div class=‘tel’>
            <span class=‘type’>work</span>
            <abbr class=‘type’ title=‘voice’> phone: </abbr>
            <span class=‘value’>+1-425-555-1212</span>
          </div>
        </div>
      ]]>
    </description>
    <enclosure url=“
http://server/SIS/contact.vcf?puid=
1688852012477191&roid=0B69B846ED7E2241AE4F6773EA749183”/>
  </item>
  </channel>
</rss>
```

And in the same example, the HTML data for the contact information might be represented as follows:

```
<html>
  <body>
    <table>
      <tr>
        <th><b>Fullname</b></th>
        <th><b>Street Address</b></th>
        <th><b>City</b></th>
        <th><b>State</b></th>
        <th><b>Zip</b></th>
        <th><b>Phone</b></th>
      </tr>
      <tr>
        <td>John Doe</td>
        <td>1 Microsoft Way </td>
        <td>Redmond</td>
        <td>WA</td>
        <td>98052</td>
        <td>+1-425-555-1212</td>
      </tr>
      <tr>
        <td>George Doe</td>
        <td>1 Microsoft Way </td>
        <td>Redmond</td>
        <td>WA</td>
        <td>+1-425-555-1212</td>
      </tr>
    </table>
  </body>
</html>
```

Given all of these data representations, a corresponding clipboard data representation might consist of the following data:

```
<?xml version=“1.0” encoding=“utf-8” ?>
<liveclipboard version=“0.92”
xmlns:lc=“http://www.microsoft.com/schemas/liveclipboard”>
<lc:data>
  <lc:format type=“vcard” contenttype=“application/xhtml+xml”>
    <lc:item>
      <div class=‘vcard’>
        <span class=‘fn n’>
          <span class=‘given-name’>John</span>
          <span class=‘family-name’>Doe</span>
        </span>
        <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
        </div>
        <div class=‘tel’>
<span class=‘type’>work</span>
<abbr class=‘type’ title=‘voice’> phone: </abbr>
<span class=‘value’>+1-978-555-1212</span>
        </div>
      </div>
    </lc:item>
    <lc:item>
      <div class=‘vcard’>
        <span class=‘fn n’>
          <span class=‘given-name’>George</span>
          <span class=‘family-name’>Doe</span>
        </span>
        <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
        </div>
        <div class=‘tel’>
            <span class=‘type’>work</span>
            <abbr class=‘type’ title=‘voice’> phone: </abbr>
            <span class=‘value’>+1-978-555-1212</span>
        </div>
      </div>
    </lc:item>
  </lc:format>
</lc:data>
<lc:feeds>
    <lc:feed type=“RSS”
    ref=“http://localhost/FriendsFeed.ashx” description=“My Friends”
    authtype=“none”>
      <lc:feeditems type=“vcard” contenttype=“application/xhtml+xml”
    xpath=“/rss/channel/item/description”>
        <lc:feeditem
id=“http://server/SIS/contact.vcf?puid=
1688852012477191&amp;roid=
4EB2576478DA9846A06EFCC12FFC0185”/>
          <lc:feeditem
id=“http://server/SIS/contact.vcf?puid=
168852012477191&amp;roid=
0B69B846ED7E2241AE4F6773EA749183”/>
        </lc:feeditems>
    </lc:feed>
  </lc:feeds>
  <lc:presentations>
    <lc:format contenttype=“text/html”>
      <table>
        <tr>
          <th>Fullname</th>
          <th>Street Address</th>
          <th>City</th>
          <th>State</th>
          <th>Zip</th>
          <th>Phone</th>
        </tr>
        <tr>
          <td>John Doe</td>
          <td>1 Microsoft Way </td>
          <td>Redmond</td>
          <td>WA</td>
          <td>+1-425-555-1212</td>
        </tr>
        <tr>
          <td>George Doe</td>
          <td>1 Microsoft Way </td>
          <td>Redmond</td>
          <td>WA</td>
          <td>+1-425-555-1212</td>
        </tr>
      </table>
    </lc:format>
  </lc:presentations>
</liveclipboard>
```

### Example Computing Environment

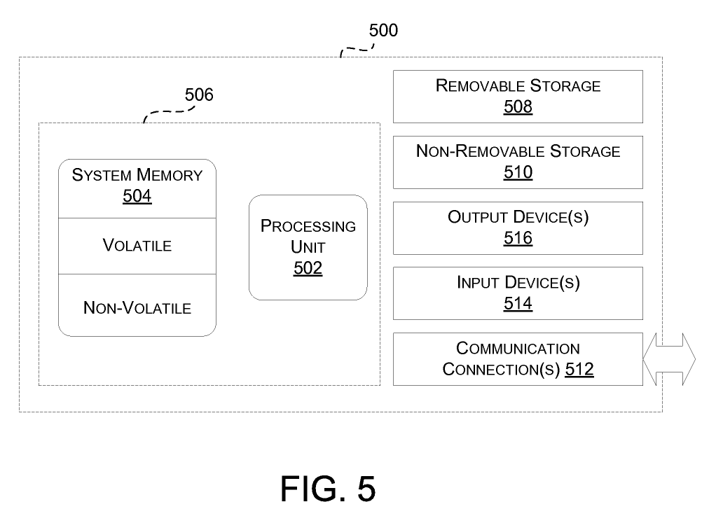

Turning now to FIG. 5, this figure and the related discussion are intended to provide a brief and general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 500 illustrated in FIG. 5.

Generally, program modules include routines, programs, objects, components, user interfaces, data structures, and so on, that perform particular tasks, display particular information, or implement particular abstract data types. Operations performed by the program modules have been described previously with the aid of one or more block diagrams and operational flowcharts.

Those skilled in the art can implement the description, block diagrams, and operational flows in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

The computing device 500 illustrated in FIG. 5, in its most basic configuration, includes at least one processing unit 502 and memory 504. In some implementations, the computing device 500 may implement all or part of, for example, the computer system 310, described previously with reference to FIG. 3. In some implementations, the processing unit 502 may be a general purpose central processing unit (CPU), as exists, for example, on a variety of computers, including desktop and laptop computers. Depending on the exact configuration and type of computing device, the memory 504 may be volatile (such as RAM), non-volatile (such as ROM, flash memory, etc.), or some combination of the two. This most basic configuration is illustrated in FIG. 5 by dashed line 506. Additionally, the computing device 500 may also have additional features and functionality. For example, the computing device 500 may also include additional storage (removable and/or non-removable) including, but not limited to, magnetic or optical disks or tape. Such additional storage is illustrated in FIG. 5 by the removable storage 508 and the non-removable storage 510.

The computing device 500 may also contain one or more communications connection(s) 512 that allow the computing device 500 to communicate with other devices and services. The computing device 500 may also have one or more input device(s) 514 such as an image input devices like cameras or scanners, keyboards, mice, pens, voice input devices including microphone arrays, touch input devices, and so on. One or more output device(s) 516 such as a display, speakers, printer, and so on, may also be included in the computing device 500.

Those skilled in the art will appreciate that the technologies described herein may be practiced with computing devices other than the computing device 500 illustrated in FIG. 5. For example, and without limitation, the technologies described herein may likewise be practiced in hand-held devices including mobile telephones and PDAs, multiprocessor systems, microprocessor-based or programmable consumer electronics, network PCs, minicomputers, mainframe computers, and the like. Each of these computing devices may be described, at some level of detail, by the system of FIG. 5, or may be described differently.

The technologies described herein may also be implemented in distributed computing environments where operations are performed by remote processing devices that are linked through a communications network. In a distributed computing environment, program modules may be located in both local and remote devices.

While described herein as being implemented in software, it will further be appreciated that the technologies described herein may alternatively be implemented all or in part as hardware, firmware, or various combinations of software, hardware, and/or firmware.

Although some particular implementations of methods and systems have been illustrated in the accompanying drawings and described in the foregoing text, it will be understood that the methods and systems shown and described are not limited to the particular implementations described, but are capable of numerous rearrangements, modifications and substitutions without departing from the spirit set forth and defined by the following claims.

What is claimed is:

1. A system, comprising:
a computer-implemented clipboard;
a source application configured to place data conforming to a data format on the clipboard;
an augmentation module configured to:
receive a notification when the data has been placed on the clipboard by the source application;
identify augmented data that has an augmented data format and is associated with the data using a clipboard converter; and
add the augmented data to the clipboard; and
an augmentation extension update module configured to:
retrieve the clipboard converter used by the augmentation module.

2. The system of claim 1, further comprising:
a data converter configured to perform data conversion processing that is platform-independent; and
wherein the clipboard converter used by the augmentation module identifies the augmented data by performing platform-dependent processing and using the data converter.

3. The system of claim 2 wherein the data converter is retrieved by the augmentation extension update module.

4. The system of claim 1, further comprising:
a second clipboard converter used by the augmentation module to identify second augmented data that has a second augmented data format and is associated with the data wherein the second augmented data format is different from the augmented data format.

5. The system of claim 1, further comprising:
a destination application configured to receive the augmented data using a paste operation.

6. The system of claim 1 wherein the source application is implemented in a first application, the augmentation module is implemented in a second application, the augmentation extension update module is implemented in a third application, and the first and second applications are different applications.

7. The system of claim 1 wherein identifying further comprises transforming the data using a transform specification.

8. The system of claim 1 wherein identifying further comprises generating the augmented data using executable code associated with at least one of the data format and the augmented data format.

9. The system of claim 1 wherein the clipboard converter is retrieved from a networked repository that holds multiple clipboard converters.

10. The system of claim 9 wherein the augmentation module and the augmentation extension module are created by a first entity and the networked repository enables a second entity that is not controlled by the first entity to add additional clipboard converters to the multiple clipboard converters, after which the clipboard converter may be retrieved from the additional clipboard converters.

11. A method, comprising:
receiving a notification that data conforming to a data format has been placed on a clipboard;
retrieving an augmentation extension;
identifying augmented data that has an augmented data format and is associated with the data using the augmentation extension; and
adding the augmented data to the clipboard.

12. The method of claim 11 wherein the augmentation extension is associated with one of the data format and the augmented data format.

13. The method of claim 11 wherein the retrieving is performed in a process that is separate from the receiving, identifying, and adding operations and the retrieving is not performed immediately in response to the notification or immediately in response to a failure to identify the augmented data.

14. The method of claim 11 wherein the retrieving is performed when the identifying operation would not otherwise be able to identify the augmented data using the data format.

15. The method of claim 11 wherein the retrieving is performed when the identifying operation would not otherwise be able to generate the augmented data in the augmented data format.

16. The method of claim 11, further comprising:
registering for paste processing; and
wherein identifying and adding are not performed until a paste operation is initiated.

17. The method of claim 11 further comprising:
retrieving a second augmentation extension that is different from the first augmentation extension;
identifying second augmented data that has a second augmented data format and is associated with the data using the second augmentation extension wherein the second augmented data format is different from the augmented data format; and
adding the second augmented data to the clipboard.

18. The method of claim 11 wherein the data format comprises:
a structured data item that uses a structured data format;
a feed data item; and
a presentation data item.

19. The method of claim 11 wherein the data is placed on the clipboard by a first application and the receiving, retrieving, identifying, and adding are performed by a second application, and the first application and the second application are different applications.

20. One or more computer-readable media containing computer-executable instructions that, when executed, implement the following operations:
receiving a notification at a first application that data conforming to a data format has been placed on a clipboard by a second application;
retrieving an augmentation extension;
identifying augmented data that has an augmented data format and is associated with the data using the augmentation extension and one of: a transform specification associated with the augmentation extension and executable code associated with the augmentation extension and at least one of the data format and the augmented data format; and
adding the augmented data to the clipboard, wherein identifying and adding are performed by the first application and the first application and the second application are different applications.
